(19) United States
(12) Patent Application Publication
(10) Pub. No.: US 2019/0275560 A1
(43) Pub. Date: Sep. 12, 2019

(54) METHOD OF PRODUCING POLYMER FILMS WITH GAS-BARRIER PROPERTIES

(71) Applicant: BASF SE, Ludwigshafen am Rhein (DE)

(72) Inventors: Ines PIETSCH, Ludwigshafen (DE); Peter PREISHUBER-PFLUEGL, Ludwigshafen (DE); Klaus HUENERFAUTH, Ludwigshafen (DE); Patrick BIPPUS, Ludwigshafen (DE); Theo SMIT, Ludwigshafen (DE)

(73) Assignee: BASF SE, Ludwigshafen am Rhein (DE)

(21) Appl. No.: 16/332,971

(22) PCT Filed: Sep. 5, 2017
(86) PCT No.: PCT/EP2017/072233

§ 371 Date: Mar. 13, 2019

(30) Foreign Application Priority Data
Sep. 14, 2016 (EP) 16188703.9

(51) Int. Cl. B05D 7/04; C08J 7/04; B05D 7/00; B05D 5/06; C08L 79/02

(52) U.S. Cl. CPC B05D 7/04; C08J 7/045; B05D 7/584; B05D 5/068; C08L 79/02; C08L 2201/14; B05D 2518/00; C08J 2323/12; C08J 2479/02; B05D 2201/02; B05D 2350/60

(57) ABSTRACT

There is provided a method of forming a metallized polymeric film comprising (1) coating a polymer film with an aqueous primer solution comprising a solution of at least one polyanion and at least one polyethyleneimine, wherein the polyanion is a polymer comprising at least partially neutralized acid groups having a weight average molecular weight of preferably at least 5000 g/mol prior to neutralization; and wherein said polyethyleneimine has a weight average molecular weight of preferably at least 25000 g/mol; and (2) depositing a metal or a metal oxide on the at least one coated side of the polymer film.

The invention relates to a method of forming a metallized or metal oxide coated polymeric film comprising (1) coating a polymer film with an aqueous primer solution comprising a solution of at least one polyanion and at least one polyethyleneimine, wherein the polyanion is a polymer comprising at least partially neutralized acid groups having a weight average molecular weight of preferably at least 5000 g/mol prior to neutralization; and wherein said polyethyleneimine has a weight average molecular weight of preferably at least 25000 g/mol; and (2) depositing a metal or a metal oxide on the at least one coated side of the polymer film. The invention also relates to polymer films obtained by the method and to the use of an aqueous solution comprising at least one polyanion and at least one polyethyleneimine as primer coating on a polymer film before metallizing the polymer film with a metal or a metal oxide.

When products that are susceptible to oxidation or products that are sensitive to oxygen are packaged, it is important that the packaging materials used have oxygen-barrier properties, i.e. that they have minimum oxygen transmission or minimum oxygen permeability. Polymer films used as packaging materials and made e.g. of polyolefins, such as polyethylene, or of oriented polypropylene, or of polyesters, e.g. polyethylene terephthalate, generally have relatively high oxygen permeability when they are used in uncoated form. Various measures have therefore been proposed for increasing the oxygen-barrier properties of these packaging materials.

One measure is to metallize the polymer films by depositing a thin layer of metal such as for example aluminum or a thin layer of metal oxide such as aluminum oxide (Alox) or silicium oxide (SiOx) on the polymer film. The metal or metal oxide layers are sometimes not completely homogenous and may have minor, microscopic defects known as pinholes. Further, microscopic cracks may form in the metal or metal oxide layer when the metallized film is crinkled or folded, known as flex cracks. Pinholes and cracks lower oxygen barrier effects.

WO 2014/071277 A1 describes a primer coating for enhancing the adhesion of a metallized coating to a substrate wherein the coating comprises amorphous polyvinyl alcohol, a polyethyleneimine and optionally an aqueous dispersion of polyurethane. WO 2013/182444 A1 describes the use of aqueous polyanion-polyethyleneimine solutions for producing polymer films with oxygen barrier properties.

U.S. Pat. No. 7,521,103 B1 describes coated polymeric films comprising a polymer film and a coating disposed on at least one side of the film, the coating comprising a copolymer of vinyl alcohol and a vinyl amine reacted with a copolymer of a maleic acid and an acrylic acid, the coating being present in an amount sufficient to increase the oxygen barrier properties of the film.

U.S. Pat. No. 6,605,344 B1 describes a gas-barrier film comprising (i) a polymer layer formed of a mixture of polyalcohol and at least one poly(meth)acrylic acid polymer selected from the group consisting of poly(meth)acrylic acids and partially neutralized poly(meth)-acrylic acids, and (ii) a metallic-compound-containing layer on a surface of the polymer layer, wherein the metallic-compound-containing layer exhibits a specific surface roughness.

U.S. Pat. No. 5,225,272 describes a metallized film comprising a substrate layer of a synthetic polymeric material having on at least one surface thereof an adherent layer and a metallic layer on the surface of the at least one adherent layer remote from the substrate. The adherent layer comprises an acrylic and/or methacrylic polymer comprising at least one monomer containing a free carboxylic group.

It was an object of the present invention to eliminate or minimize pinhole formation and/or flex crack formation of metallized and metal oxide coated polymer films in order to further improve gas barrier effectiveness of metallized polymer films, in particular good oxygen-barrier properties in high humidity environments.

The invention provides a method of forming a metallized or metal oxide coated polymeric film comprising the steps of:

(1) coating at least one side of a polymer film with an aqueous primer solution, the aqueous primer solution comprising a solution of at least one polyanion and at least one polyethyleneimine,
wherein the polyanion is a polymer comprising at least partially neutralized acid groups having a weight average molecular weight of preferably at least 5000 g/mol prior to neutralization; and wherein said polyethyleneimine has a weight average molecular weight of preferably at least 25000 g/mol; and
(2) depositing a metal or a metal oxide on the at least one primer coated side of the polymer film.

The invention also provides a coated polymer film comprising a gas barrier coating obtainable by the method according to the invention as described herein, wherein at least one side of the polymer film has been coated with an aqueous primer solution comprising at least one polyanion and at least one polyethyleneimine, wherein the polyanion is a polymer comprising at least partially neutralized acid groups having a weight average molecular weight of preferably at least 5000 g/mol prior to neutralization; and wherein said polyethyleneimine has a weight average molecular weight of preferably at least 25000 g/mol; and the at least one side of the polymer film which has been coated with the aqueous primer solution is metallized by a deposited metal or metal oxide.

Improved gas barrier property could be e.g. oxygen, CO2, water vapor, flavor or scent barrier, preferably at least oxygen barrier.

The molecular weight can be determined by gel permeation chromatography (GPC). For polyethyleneimine pullulan is used as standard in a water based solution (water, 0.02 mol/l fumaric acid, 0.2 mol/l KCl); for the polyanion polyacrylic acid is used as standard with water as eluant.

The coating produced according to the invention using the aqueous solution of polymers as primer for a metallization has oxygen-barrier properties. The barrier properties can be measured by the permeability test described in the examples. The term oxygen-barrier property means that oxygen transmission rate (OTR) has been reduced in comparison with an uncoated substrate. The oxygen transmission rate of polymer films coated according to the invention is preferably less than 20%, in particular less than 10%, or less than 5%, e.g. from 1 to 3%, of the value for the uncoated polymer film measured at 23° C. and 50% relative humidity; and preferably less than 30% or less than 20% or less than 10% measured at 23° C. and 85% relative humidity.

The aqueous solution of polymers contains preferably from 10 to 90 wt. %, more preferably from 20 to 80 wt. % of the polyanion, referring to solids content.

The aqueous solution of polymers contains preferably from 10 to 90 wt. %, more preferably from 20 to 80 wt. % of the polyethyleneimine, referring to solids content.

The weight ratio of the polyanion (calculated without neutralizing agent) to the polyethyleneimine is preferably from 10:1 to 10:9, more preferably from 10:2 to 10:5 or from 10:3 to 10:4.

The concentration of the sum of polyanion and polyethyleneimine in the aqueous solution, is preferably at least 1% by weight, in particular at least 5% by weight and up to 50% by weight or up to 60% by weight, for example from 1 to 50% by weight or from 5 to 40% by weight.

The polyanion is a polymer comprising neutralized acid groups, also named anionic polymer. Anionic polymers are polymers having anionic or acidic groups, in particular organic polymers having carboxylate, phosphate, or sulfate groups or the corresponding acid groups. The term “anionic polymer” also comprises the corresponding polymers with acid groups, as long as they are at least partially neutralized by bases when used in the aqueous solution according to the invention.

Examples of suitable anionic polymers are those formed by polymerization of ethylenically unsaturated anionic monomers. The term “anionic monomer” comprises monomers with at least one anionic or acidic group, wherein the acidic group can be neutralized by a base. The group of anionic polymers also comprises copolymers made of at least one anionic monomer and of one or more than one different non-ionic, non-acidic copolymerizable monomer(s). The polyanion can also be synthesized by polymerization of one or more non-ionic monomers such as acid derivatives like for example ethylenically unsaturated acid esters, followed by a hydrolysis to obtain an anionic polymer. Suitable non-ionic monomers can be alkyl acrylates, alkyl methacrylates (e.g. tert-butyl acrylate, ethyl acrylate etc.) or ethylenically unsaturated acid anhydrids such as maleic anhydride.

Examples of ethylenically unsaturated anionic monomers that can be used are monoethylenically unsaturated C₃ to C₁₀ or C₃ to C₅ carboxylic acids, such as acrylic acid, methacrylic acid, ethacrylic acid, crotonic acid, maleic acid, fumaric acid, vinylsulfonic acid, styrenesulfonic acid, acrylamidomethylpropanesulfonic acid, vinylphosphonic acid, itaconic acid, and salts of these acids such as the alkali-metal salts, alkaline-earth-metal salts, or ammonium salts of these acids. Among the anionic monomers preferably used are acrylic acid, methacrylic acid, maleic acid, itaconic acid and 2-acrylamido-2-methylpropanesulfonic acid. Particular preference is given to aqueous solutions of polymers based on acrylic acid. The anionic monomers can either be polymerized alone to give homopolymers or else can be polymerized in a mixture with one another to give copolymers. Examples of these are the homopolymers of acrylic acid, homopolymers of methacrylic acid, copolymers of acrylic acid and maleic acid, copolymers of acrylic acid and methacrylic acid, and copolymers of methacrylic acid and maleic acid. Preferably, the polyanion is selected from polymers capable of being produced from monomers selected from the group consisting of monoethylenically unsaturated C₃ to C₁₀ carboxylic acids, vinylsulfonic acid, styrenesulfonic acid, acrylamidomethylpropanesulfonic acid, vinylphosphonic acid, and salts of these acids, preferably acrylic acid, methacrylic acid, maleic acid, itaconic acid. Most preferably the polyanion is a polyacrylic acid or a copolymer of acrylic acid and maleic acid.

However, the anionic monomers can also be polymerized in the presence of at least one other ethylenically unsaturated monomer. These monomers can be nonionic or can bear a cationic charge. Examples of nonionic comonomers are acrylamide, methacrylamide, N—C₁ to C₃-alkylacrylamides, N-vinylformamide, acrylic esters of monohydric alcohols having from 1 to 20 carbon atoms, e.g. in particular methyl acrylate, ethyl acrylate, isobutyl acrylate, and n-butyl acrylate, methacrylic esters of monohydric alcohols having from 1 to 20 carbon atoms, e.g. methyl methacrylate and ethyl methacrylate, and also vinyl acetate and vinyl propionate.

Suitable cationic monomers which can be copolymerized with the anionic monomers are dialkylaminoethyl acrylates, dialkylaminoethyl methacrylates, dialkylaminopropyl acrylates, dialkylaminopropyl methacrylates, dialkylaminoethylacrylamides, dialkylaminoethylmethacrylamides, dialkylaminopropylacrylamides, dialkylaminopropyl-methacrylamides, diallyldimethylammonium chloride, vinylimidazole, and also the respective basic monomers neutralized with acids and/or quaternized. Individual examples of cationic monomers are dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate, and diethylaminopropyl methacrylate, dimethylaminoethylacrylamide, dimethylamino-ethylmethacrylamide, dimethylaminopropylacrylamide, dimethylaminopropylmeth-acrylamide, diethylaminoethylacrylamid, and diethylaminopropylacrylamide.

The basic monomers can have been completely or only to some extent neutralized or quaternized, for example to an extent of from 1 to 99% in each case. Preferred quaternizing agent used for the basic monomers is dimethyl sulfate. However, the monomers can also be quaternized with diethyl sulfate or with alkyl halides, such as methyl chloride, ethyl chloride, or benzyl chloride. The amount used of the cationic monomers is at most such that the resultant polymer bears a net charge which is anionic at pH <6.0 and a temperature of 20° C. The excess of anionic charge in the resultant amphoteric polymers is, for example, at least 5 mol %, preferably at least 10 mol %.

The amounts of the non-anionic, non-acidic comonomers used in the production of the anionic polymers are such that the resultant polymers are water-soluble when diluted with water at pH above 7.0 and at a temperature of 20° C. (i.e. solubility in water more than 10 g/I at 20° C. and pH 7), and have an anionic net charge. Examples of the amount of non-anionic, non-acidic comonomers, based on the total amount of monomers used in the polymerization reaction, are from 0 to 99% by weight, preferably from 1 to 75% by weight, and mostly an amount in the range from 1 to 25% by weight.

Examples of preferred copolymers are copolymers made of from 25 to 90% by weight of acrylic acid and from 75 to 10% by weight of acrylamide. It is preferable to polymerize at least one ethylenically unsaturated C₃ to C₅ carboxylic acid in the absence of other monoethylenically unsaturated monomers. Particular preference is given to homopolymers of acrylic acid, obtainable via free-radical polymerization of acrylic acid in the absence of other monomers; or to copolymers of acrylic acid and maleic acid.

In one embodiment, the anionic polymer comprises 2-acrylamido-2-methylpropanesulfonic acid (AMPS). It is preferable to copolymerize acrylic acid with AMPS. The amount of AMPS here can be, for example, from 0.1 to 15 mol % or from 0.5 to 10 mol %, based on the amount of all of the monomers.

The polymerization reaction for making the anionic polymer can also be conducted in the presence of at least one crosslinking agent. This then gives copolymers with higher molar mass than when the anionic monomers are polymerized in the absence of any crosslinking agent. Crosslinking agents used can comprise any of the compounds that have at least two ethylenically unsaturated double bonds within the molecule.

Examples of crosslinking agents are triallylamine, the triallyl ether of pentaerythritol, the tetra allyl ether of pentaerythritol, methylenebisacrylamide, N,N′-divinylethyleneurea, allyl ethers comprising at least two allyl groups, or vinyl ethers having at least two vinyl groups, where these ethers derive from polyhydric alcohols, e.g. sorbitol, 1,2-ethane-diol, 1,4-butanediol, trimethylolpropane, glycerol, diethylene glycol, and from sugars, such as sucrose, glucose, mannose; other examples are dihydric alcohols which have from 2 to 4 carbon atoms and which have been completely esterified with acrylic acid or with methacrylic acid, e.g. ethylene glycol dimethacrylate, ethylene glycol diacrylate, butanediol dimethacrylate, butanediol diacrylate, diacrylates or dimethacrylates of polyethylene glycols with molecular weights from 300 to 600, ethoxylated trimethylenepropane triacrylates or ethoxylated trimethylenepropane trimethacrylates, 2,2-bis-(hydroxymethyl)butanol trimethacrylate, pentaerythritol triacrylate, pentaerythritol tetraacrylate, and triallylmethylammonium chloride. If crosslinking agents are used in the production of the solutions of the invention, examples of the respective amounts used of crosslinking agent are from 0.0005 to 5.0% by weight, preferably from 0.001 to 1.0% by weight, based on the entirety of monomers used in the polymerization reaction, provided that the polymer remains water-soluble at pH >7. Crosslinking agents preferably used are the triallyl ether of pentaerythritol, the tetra allyl ether of pentaerythritol, N,N″-divinylethylene urea, allyl ethers of sugars such as sucrose, glucose or mannose, where these ethers comprise at least two allyl groups, and triallylamine, and also mixtures of these compounds.

If at least one anionic monomer is polymerized in the presence of at least one crosslinking agent, it is preferable to produce crosslinked copolymers of acrylic acid and/or methacrylic acid by polymerizing acrylic acid and/or methacrylic acid in the presence of the triallyl ether of pentaerythritol, the tetra allyl ether of pentaerythritol, N,N″-divinylethyleneurea, allyl ethers of sugars such as sucrose, glucose or mannose, where these ethers comprise at least two allyl groups, and triallylamine, and also mixtures of these compounds. Preferably the amounts of crosslinking agents used in the polymerization reaction are limited to an extent so that the resultant anionic polymers are soluble in aqueous solution at pH >7.0.

The weight average molecular weight of the polymer comprising acid groups prior to neutralization is preferably at least 5000 g/mol, more preferably at least 10000 g/mol, for example from 5000 to 200000 g/mol or from 10000 to 150000 g/mol.

The acid groups of the polyanion are partially or completely neutralized with at least one base. The base is preferably selected from the group consisting of inorganic bases and monovalent organic bases. A monovalent organic base is an organic compound with a single basic group, e.g. a single amino group. Bases are for example NaOH, KOH, Ca(OH)2, Ba(OH)2, sodium carbonate, potassium carbonate, trisodium phosphate, ammonia or primary, secondary or tertiary organic amines. Preferred bases are ammonia, sodium hydroxide and triethanol amine. Most preferred are volatile bases such as ammonia.

The degree of neutralization of the polyanion is preferably from 30 to 100%, more preferably from 50 to 100%, based on the total molar amount of acidic groups of the anionic polymer.

The aqueous solution comprises at least one polyethyleneimine. Polyethyleneimines are polymers comprising ethyleneimine units. They are preferably branched. The polyethyleneimines can be used neutralized in the form of the salts with suitable acids but are preferably used in unneutralized form.

In one embodiment of the invention, the polyethyleneimine is selected from highly branched or dendritic polyethyleneimines. Highly branched polyethyleneimines are characterized by their high degree of branching (DB). The DB can be determined by ¹³C-NMR-spectroscopy, preferably in D₂O, and is defined as:

DB=D+T/(D+T+L)

wherein D (dendritic) correlates to the amount of tertiary amine groups, L (linear) correlates to the amount of secondary amine groups and T (terminal) correlates to the amount of primary amine groups. Highly branched polyethyleneimines according to the invention have a DB of preferably from 0.1 to 0.95, or from 0.25 to 0.9, more preferred from 0.30 to 0.80 and especially preferred of at least 0.5. Dendritic polyethyleneimines have a structural and molecular uniform constitution (DB=1).

The weight average molecular weight of the polyethylene imines is at least 25000 g/mol, more preferably at least 100000 g/mol, for example from 25000 to 3 million g/mol or from 100000 to 2 million g/mol. The charge density of the polyethylene imines is preferably from 1 to 35 meq/g, more preferably from 5 to 25 meq/g. Charge density can be measured by titration of aqueous solutions of the polyethyleneimine with potassium polyvinyl sulfate (KPVS) at pH 4.5 with toluidine blue as indicator.

Suitable cationic polymers are polymers of ethyleneimine which are produced via polymerization of ethyleneimine in an aqueous medium in the presence of small amounts of acids or of acid-forming compounds, examples being halogenated hydrocarbons, e.g. chloroform, carbon tetrachloride, tetrachloroethane, or ethyl chloride, or are condensates of epichlorohydrin and compounds comprising amino groups, examples being mono- and polyamines, e.g. dimethylamine, diethylamine, ethylenediamine, diethylenetriamine, and triethylenetetramine, or ammonia. By way of example, they have molecular weights M_{w} of from 25000 to 3 million, preferably from 100000 to 2 million g/mol.

This group of cationic polymers also includes graft polymers of ethyleneimine on compounds having a primary or secondary amino group, examples being polyamidoamines made of dicarboxylic acids and of polyamines. The ethyleneimine-grafted polyamidoamines can also, if appropriate, be reacted with bifunctional crosslinking agents, for example with epichlorohydrin or with bischlorohydrin ethers of polyalkylene glycols.

In one embodiment, the polyethyleneimine is cross-linked. Any crosslinking agent with at least two functional groups capable of forming covalent bonds with amine groups of the polyethyleneimine can be used for crosslinking. Suitable crosslinking agents are for example alkyldialdehyds with preferably 3 to 20 C-atoms such as glutaraldehyd (1,5-pentanedial).

In one embodiment, the polyethylenimine is modified with molecules with functional groups capable of forming covalent bonds with amino groups. Suitable molecules could be aldehydes or carboxylic acids.

The aqueous solution may comprise water as the only solvent or it may comprise a mixture of water and water miscible organic solvents such as methanol, ethanol, acetone or tetrahydrofuran. Preferably water is the only solvent. The pH is preferably from 6 to 12, more preferably from 7 to 10.

The aqueous coating composition can be applied by typical coating machinery to a backing film made of a thermoplastic material. If materials in the form of webs are used, the aqueous polymer solution is usually applied from a trough by way of an applicator roll and rendered uniform with the aid of an air knife. Other suitable possibilities for applying the coating use the reverse gravure process, or spray processes, or a spreader system that uses a roll, or other coating processes known to the person skilled in the art.

The aqueous coating can also be applied in a multi-coating process, wherein a first coating is followed by a second or more coating.

Other suitable coating processes are the known intaglio printing and relief printing processes. Instead of using different inks in the printing-ink units, the process here by way of example uses a printing process for application of the aqueous polymer solution. Printing processes that may be mentioned are the flexographic printing process as a relief printing process known to the person skilled in the art, the gravure process as an example of intaglio printing, and offset printing as an example of flatbed printing. Modern digital printing, inkjet printing, electrophotography and direct imaging can also be used.

In order to achieve a further improvement in adhesion on a polymer film, the backing film can be subjected to a surface treatment prior to coating with the primer composition. A typical surface treatment could be corona treatment. Examples of the amounts applied to the sheet materials are preferably from 0.01 to 50 g (polymer, solid) per m², preferably from 0.2 to 10 g/m² or from 0.3 to 3 g/m².

Once the aqueous primer composition has been applied to the sheet substrates, the solvent is evaporated. For this, by way of example, in the case of continuous operation, the material can be passed through a drying tunnel, which can have an infrared irradiation apparatus. The coated and dried material is then passed over a cooling roll and finally wound up. The thickness of the dried primer coating is preferably from 0.01 to 50 μm, particularly preferably from 0.2 to 10 μm, most preferred from 0.3 to 3 μm.

The deposition of metal or metal oxide (both also referred to as metallization) can be done by various process steps, including for example vacuum metallization, arc and flame spraying or electroplating etc. A preferred process, in particular for packaging purposes, is vacuum metallization. Vacuum coating and metallizing is the process of adding a thin film of coating material, such as for example aluminum, to a material (see http://www.bobst.com/usen/products/vacuum-coating-metallizing/process). In principle, the process calls for the evaporation of the coating material inside a vacuum chamber, after which it condenses onto a web of substrate as it passes through. A vacuum coater, also referred to as a vacuum metallizer or barrier coating machine, consists of a vacuum chamber which has been evacuated to, typically, 0.0005 mbar. Inside this chamber, aluminum wire is fed onto individual, resistance-heated inter-metallic evaporators, where the aluminum becomes molten and evaporates. The flexible substrate, supported on a chilled process drum, passes over the evaporation source at speeds of up to 1000 m/min. The aluminum vapor condenses onto the substrate and so creates the coating layer.

The metallized film of the present invention can be produced by vapor-depositing a metal or a metal oxide onto a base film. The base film can be produced by conventional film forming method such as for example a blown film forming method, a T-die method, or a calendering method. The base film prior to being subjected to metallization may have been drawn. A drawn base film can be produced by drawing a film or a sheet prepared from a resin composition. Examples of methods for the drawing include methods involving uniaxially or biaxially drawing films by a roll drawing process, a tenter drawing process, a tubular drawing process, or the like. Before the metallization, surface treatment, such as corona discharge treatment, plasma treatment, and flame treatment, may be applied to the base film on its surface on which a metal or a metal oxide is to be deposited. Corona treatment is preferred.

The thickness of the base film onto which a metal or a metal oxide is to be deposited is preferably 1 μm to 500 μm, more preferably 5 μm to 100 μm.

Preferred metal materials for metal deposition are selected from the group consisting of aluminum, titanium, chromium, nickel, copper, germanium, tin, and selenium, and examples of the metal oxide include silica and aluminum oxide. Preferable is aluminum, silica, or aluminum oxide, most preferred is aluminum.

The thickness of the metallized layer is preferably 50 Å to 1000 Å, preferably 100 Å to 700 Å.

One embodiment of the invention is a polymer film comprising an oxygen barrier coating wherein at least one side of the polymer film has been coated with an aqueous primer solution comprising a solution of at least one polyanion and at least one polyethyleneimine (as described above),

wherein the polyanion is a polymer comprising at least partially neutralized acid groups having a weight average molecular weight of preferably at least 5000 g/mol prior to neutralization; and
wherein said polyethyleneimine has a weight average molecular weight of preferably at least 25000 g/mol; and
the at least one side of the polymer film which has been coated with the aqueous primer solution is metallized by a deposited metal or metal oxide.

The aqueous polymer solutions used for the coating process can comprise further additives or auxiliaries, e.g. thickeners for adjusting rheology, wetting aids, or binders. Preferred polymer film substrates are polymer films which are suitable for packaging.

Preferred polymer films are made of oriented polypropylene or polyethylene, where the polyethylene can have been produced from ethylene either by the high-pressure polymerization process or by the low-pressure polymerization process. Examples of other suitable polymer films are made of polyester, such as polyethylene terephthalate, and films made of polyamide, polystyrene and polyvinyl chloride. In one embodiment, the polymer film is biodegradable, e.g. made of biodegradable aliphatic-aromatic copolyesters and/or polylactic acid, an example being Ecoflex® films or Ecovio® films. Examples of suitable copolyesters are those formed from alkanediols, in particular C2 to C8 alkanediols, e.g. 1,4-butanediol, and from aliphatic dicarboxylic acids, in particular C2 to C8 dicarboxylic acids, e.g. adipic acid, and from aromatic dicarboxylic acids, e.g. terephthalic acid.

Preferred polymer film materials are selected from polyethylene terephthalate, oriented polypropylene, casted polypropylene, polyethylene, biodegradable aliphatic-aromatic copolyesters, and polyamide.

The thickness of the polymer film can be in the range from 5 to 400 μm, in the case of films made of polyamide from 5 to 50 μm, in the case of films made of polyethylene terephthalate from 10 to 100 μm, in case of oriented polypropylene form 10 to 100 μm, in the case of films of polyvinyl chloride about 50-300 μm, and in the case of films made of polystyrene about 30-75 μm.

Preferably, the oxygen barrier coating on the polymer film is pore-free, which can be analyzed by atomic force microscopy (AFM) or scanning electron microscope (SEM).

The metallized polymeric films of the invention exhibit excellent oxygen-barrier action, in particular in high humidity environments. The coated substrates can be used for example as means of packaging, preferably for packaging foods.

The oxygen barrier coating can also be used as a barrier coating against other substances, which could be gases, liquids or solids. Such substances can be carbon dioxide, nitrogen, bisphenol A (BPA), mineral oil, fat, aldehydes, grease, plasticizer, photoinitiators or aroma substances.

As well known from several examples in literature (i.e. EP 680823) the properties of metallized or metal oxide coated films could be improved by applying an additional coating with barrier properties. In order to obtain specific additional surface properties or specific coating properties of the metallized or metal oxide coated polymer films, for example good printability, or further improved sealing and non-blocking properties, or good water-resistance, or further enhanced gas barrier properties, it can be advantageous to overcoat the metallized or metal oxide coated polymer films with additional layers which provide these desired additional properties. The metallized films according to the invention can readily be overcoated. For the overcoating process, one of the processes mentioned above can be repeated, or repeated coating can be carried out in a continuous process without any intervening wind-up and unwind of the foil. The surface properties are then determined by the additional layer.

In one embodiment, a polymer film of the invention comprises in addition to the oxygen barrier coating (primer coating plus metallization) at least one additional layer made from materials selected from the group consisting of polyacrylates, polyvinylidene chloride (PVDC), waxes, epoxy resins, UV curable acrylates and polyurethanes and solutions comprising at least one polyanion and at least one polyethyleneimine.

A preferred metallized or metal oxide coated polymer film of the invention is a polymer film which has been coated with the aqueous primer solution and is metallized by deposited aluminum in the presence of oxygen to result in an aluminium oxide coated film and the metallization layer is overcoated with an additional layer made of a solution comprising at least one polyanion and at least one polyethyleneimine.

Another preferred metallized polymer film of the invention is a polymer film which has been coated with the aqueous primer solution and is metallized by deposited aluminum and the metallization layer is overcoated with an additional layer made of a solution comprising at least one polyanion and at least one polyethyleneimine.

In one embodiment of the invention a metallized polymer film of the invention as described above is laminated with at least one additional material wherein the at least one additional material is selected from polyethylene terephthalate, oriented polypropylene, polyethylene, casted polypropylene, biodegradable aliphatic-aromatic copolyesters, metallized polyethylene terephthalate, metallized oriented polypropylene, polyamide, paper and board.

Another embodiment of the invention is a package comprising a polymer film or laminated film according to the invention as described above.

Use of the aqueous primer solution according to the invention reduces the amounts of pinholes, as measured by Scanning Electron Microscopy (SEM), and thereby further improving the gas barrier effect.

### EXAMPLES

### Abbreviations

PEI aqueous solution of polyethyleneimine, Mw=750000 g/mol; charge density 17 meq/g, pH=11, Lupasol® P
PAS copolymer of polyacrylic acid and maleic acid (75:25), Mw=80000 g/mol
BOPP biaxial oriented polypropylene
BOPP met biaxial oriented polypropylene, metallized on one side with aluminum Metallization is achieved by vapor deposition of aluminum.
Primer Aqueous primer solution of:
   100 parts by weight of PAS, 25 parts by weight ammonia, 40 parts by weight PEI. The PAS is pre-neutralized with ammonia before combining with the polyethylene imine.

Measurement of Oxygen-Barrier Action:

Oxygen transmission is determined on coatings on polymer films at a relative humidity (RH) level as indicated below. Measurements are done with 100% oxygen gas at a temperature of 23° C.

Carrier Material:

polymer film of BOPP (biaxial oriented polypropylene) with a thickness of 20 μm.

Oxygen transmission rate of the uncoated BOPP film at 85% RH/23° C.:

about 975 cm³/(m²*d).

The determination method is based on ASTM D3985, using a coulometric sensor. Each sample is measured twice and the mean result is calculated.

The transmission of a multi-layer system is calculated according to the equation

$$\frac{1}{{TR}_{total}} = \frac{1}{{TR}_{A}} + \frac{1}{{TR}_{B}} + …$$

wherein TRₜₒₜₐₗ is the oxygen transmission of the multi-layer film and TR_{A} and TR_{B} are the oxygen transmissions of layer A and layer B, respectively.

The BOPP-Films are coated and metallized (“met”) as summarized in Table 1. The samples according to the invention are coated with the primer prior to metallization. The results of oxygen transmission rate measurements are summarized in Table 1.

TABLE 1
oxygen transmission rate measurement results

| | | | | Oxygen |
|---|---|---|---|---|
| | | Layer | Relative | transmission |
| | Layer | thickness | humidity | rate cm³/ |
| sample | structure | [μm] | [%] | (m²*d) |
| 1a | BOPP met | 20 + met | 50 | 29 |
| 1b | BOPP met | 20 + met | 85 | 29 |
| 2a | BOPP + | 20 + 1.2 | | 4.3 |
| | Primer | | 50 | |
| 2b | BOPP + | 20 + 1.2 | 75 | 12.2 |
| | Primer | | | |
| 3a | BOPP + | 20 + 1.2 + met | 50 | 0.5 |
| | Primer + | | | |
| | met | | | |
| 3b | BOPP + | 20 + 1.2 + met | 85 | 3.6 |
| | Primer + | | | |
| | met | | | |

Evaluation of Pinhole Formation

Metallized BOPP films were analyzed by Scanning Electron Microscopy (SEM). The detected pinholes and defects on an area of about 0.5 mm² were counted. The results were averaged for three representative areas for each film.

The results are evaluated according to the following rating scheme:

rating 1=no pinholes or defects
rating 2=1 to 5 pinholes or defects per 0.5 mm²
rating 3=6 to 10 pinholes or defects per 0.5 mm²
rating 4=more than 10 pinholes or defects per 0.5 mm²

TABLE 2
Evaluation of pinhole formation
of metallized polymer films

| | Layer | Pinhole and |
|---|---|---|
| sample | structure | defect rating |
| 1 | BOPP met | 4 |
| 3 | BOPP + Primer + met | 1-2 |

The data show that coating with the primer significantly reduced pinhole formation and defects of the subsequent metallization.

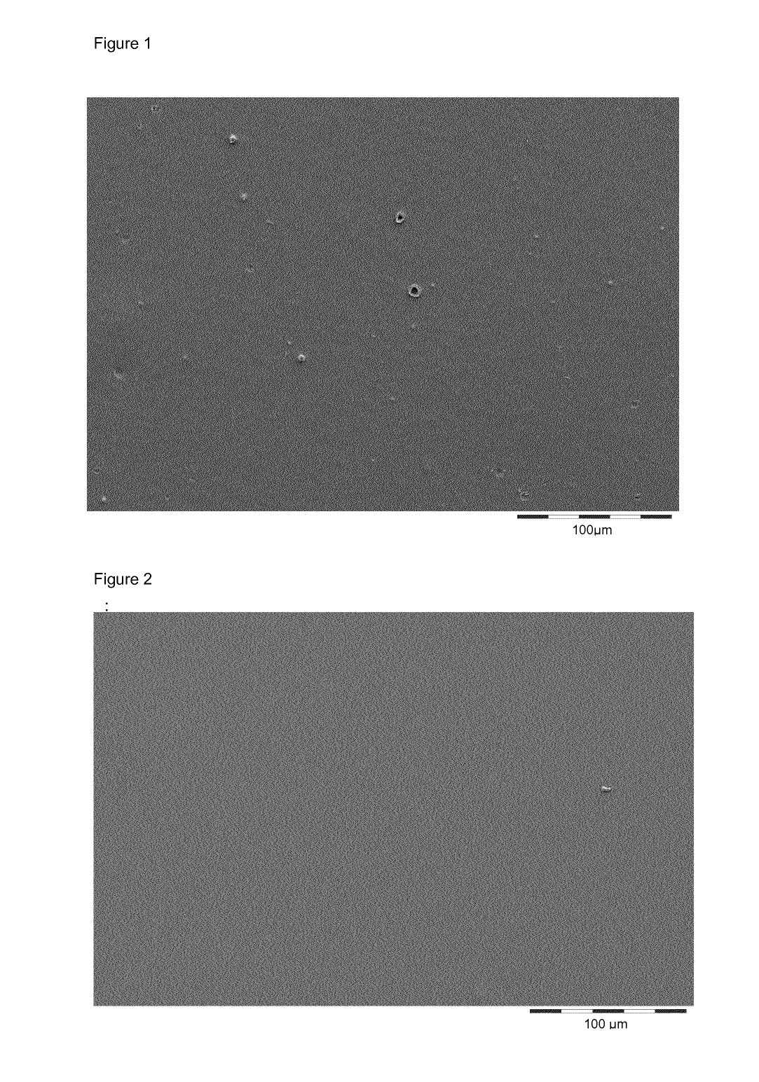

FIG. 1:

FIG. 1 shows a Scanning Electron Microscopy picture of the surface of metallized BOPP film without primer coating (sample 1)

FIG. 2:

FIG. 2 shows a Scanning Electron Microscopy picture of the surface of metallized BOPP film with primer coating prior to metallization (sample 3)

1. A method of forming a metallized or metal oxide coated polymeric film, the method comprising:
(1) coating at least one side of a polymer film with an aqueous primer solution, which comprises a solution of at least one polyanion and at least one polyethyleneimine,
wherein the polyanion is a polymer comprising at least partially neutralized acid groups; and
(2) depositing a metal or a metal oxide on the at least one primer coated side of the polymer film.

2. The method of claim 1, wherein the polyanion is a polymer comprising acid groups neutralized with at least one base selected from the group consisting of an inorganic base and a monovalent organic base.

3. The method according to claim 1, wherein the aqueous primer solution contains
(a) from 10 to 90 wt. %, referring to solids content, of the polyanion and
(b) from 10 to 90 wt. %, referring to solids content, of the polyethyleneimine.

4. The method according to claim 1, wherein the polyanion is a polymer produced from at least one monomer selected from the group consisting of a monoethylenically unsaturated C₃ to C₁₀ carboxylic acid and a salt thereof, vinylsulfonic acid and a salt thereof, styrenesulfonic acid and a salt thereof, acrylamidomethylpropanesulfonic acid and a salt thereof, and vinylphosphonic acid and a salt thereof.

5. The method according to claim 1, wherein the polymer comprising acid groups has a weight average molecular weight ranging from 5000 to 200000 g/mol.

6. The method according to claim 1, wherein the polyethyleneimine is branched, and has a weight average molecular weight ranging from 25000 to 3 million g/mol and a charge density ranging from 1 to 35 meq/g.

7. The method according to claim 1, wherein the polyanion has a degree of neutralization ranging from 30 to 100% and the aqueous solution has a pH ranging from 6 to 12.

8. The method according to claim 2, wherein the base is at least one selected from the group consisting of ammonia, sodium hydroxide and triethanol amine.

9. The method according to claim 1, wherein the metal or metal oxide is at least one selected from one or more of the group consisting of aluminum, titanium, chromium, nickel, copper, germanium, tin, selenium, silicium oxide and aluminum oxide.

10. The method according to claim 1, wherein said depositing (2) is done by vacuum metallization, arc and flame spraying, or electroplating.

11. A polymer film, comprising: an oxygen barrier coating, wherein
at least one side of the polymer film is coated with an aqueous primer solution comprising a solution of at least one polyanion and at least one polyethyleneimine,
the polyanion is a polymer comprising at least partially neutralized acid groups, and
the at least one side of the polymer film which is coated with the aqueous primer solution is metallized by a deposited metal or metal oxide.

12. The polymer film according to claim 11, wherein
the polymer film is selected from the group consisting of polyethylene terephthalate, oriented polypropylene, polyethylene, casted polypropylene, a biodegradable aliphatic-aromatic copolyester, and polyamide, and
the metal or metal oxide is at least one selected from the group consisting of aluminum, titanium, chromium, nickel, copper, germanium, tin, selenium, silica and aluminum oxide.

13. The polymer film according to claim 11, wherein the primer layer after drying has a thickness ranging from 0.01 to 50 μm.

14. The polymer film according to claim 11, further comprising: at least one additional layer made from at least one material selected from the group consisting of a polyacrylate, polyvinylidene chloride, a wax, an epoxy resin, a UV curable acrylate, a polyurethane, and a solution comprising at least one polyanion and at least one polyethyleneimine.

15. The polymer film according to claim 11, which is laminated with at least one additional material, which is selected from the group consisting of polyethylene terephthalate, oriented polypropylene, polyethylene, casted polypropylene, a biodegradable aliphatic-aromatic copolyester, metallized polyethylene terephthalate, metallized oriented polypropylene, polyamide, paper, and board.

16. The polymer film according to claim 11, which is metallized by deposited aluminum oxide and the metallization layer is overcoated with an additional layer made of a solution comprising at least one polyanion and at least one polyethyleneimine.

17. A package, comprising: the polymer film according to claim 11.

18. A method for coating a polymer film, the method comprising:
coating the polymer film with an aqueous solution comprising at least one polyanion and at least one polyethyleneimine as primer coating.

19. The method according to claim 18, wherein
the polyanion is a polymer comprising at least partially neutralized acid groups and the polymer comprising acid groups having a weight average molecular weight of at least 5000 g/mol prior to neutralization; and
the polyethyleneimine has a weight average molecular weight of at least 25000 g/mol.
